(19) United States
(12) Patent Application Publication
(10) Pub. No.: US 2019/0338382 A1
(43) Pub. Date: Nov. 7, 2019

(54) METHOD FOR HEAT-TREATING METAL MOLDED ARTICLE AND MANUFACTURING METHOD

(71) Applicant: MITSUBISHI HEAVY INDUSTRIES, LTD., Tokyo (JP)

(72) Inventors: Kousuke FUJIWARA, Tokyo (JP); Hidetaka HARAGUCHI, Tokyo (JP); Shuji TANIGAWA, Tokyo (JP); Masashi KITAMURA, Tokyo (JP); Masaki TANEIKE, Tokyo (JP); Nobuhiko SAITO, Tokyo (JP); Toshinobu OHARA, Tokyo (JP)

(21) Appl. No.: 16/466,797

(22) PCT Filed: Jan. 31, 2018
(86) PCT No.: PCT/JP2018/003083

§ 371 Date: Jun. 5, 2019

(30) Foreign Application Priority Data
Jan. 31, 2017 (JP) 2017-015275

(51) Int. Cl. C21D 1/70; B22F 3/24; C22F 1/10; B22F 3/16; B33Y 10/00; B33Y 40/00

(52) U.S. Cl. CPC C21D 1/70; B22F 3/24; C22F 1/10; B22F 2301/15; B33Y 10/00; B33Y 40/00; B22F 2003/248; B22F 3/16

(57) ABSTRACT

A method of heat-treating for a metal molded article includes: a shape holding layer formation step of forming on a shape holding layer having a melting point higher than a solidus temperature Ts of a composition of the metal molded article on a surface of the metal molded article by treating the metal molded article; and a first heat-treatment step of performing a first heat treatment on the metal molded article at a first temperature T1, after forming the shape holding layer. When a reference temperature Ta is a temperature lower than the solidus temperature Ts by 100° C., and Tm is the melting point of the shape holding layer, the shape holding layer formation step and the first heat-treatment step are performed so as to satisfy an expression Ta≤T1≤Tm.

### TECHNICAL FIELD

The present disclosure relates to a method for heat-treating a metal molded article and a manufacturing method.

### BACKGROUND ART

To change the characteristics of a metal molded article, heat treatment is performed on the metal molded article in some cases. For instance, Patent Document 1 discloses a technique of heat-treating for a metal molded article formed by 3D additive manufacturing (metal additive manufacturing) at a temperature not lower than the recrystallization temperature of the metal member, in order to reduce the anisotropic characteristics in the horizontal and vertical directions.

### CITATION LIST

### Patent Literature

### Patent Document 1: JP5901585B

### SUMMARY

### Problems to be Solved

Meanwhile, to change the characteristics of a metal molded article, heat treatment is performed on the metal molded article in some cases at a temperature near or not lower than the solidus temperature of the composition of the metal molded article. In a case where such heat treatment is performed on the metal molded article, strength deterioration or partial melting of the metal molded article may occur due to high temperature. FIG. 9 is a diagram showing a state where partial melting has occurred in a grain boundary as a result of performing heat treatment on an Ni-based heat resistant alloy at a temperature near the solidus temperature. If such strength deterioration or partial melting of a metal molded article occurs due to high temperature, the metal molded article deforms and it is no longer possible to maintain the desired shape of the metal molded article.

At least one embodiment of the present invention was made in view of the above described typical issue, and an object of at least one embodiment of the present invention is to provide a method for heat-treating a metal molded article and a manufacturing method whereby it is possible to change the characteristics of the metal molded article appropriately while suppressing deformation of the metal molded article.

### Solution to the Problems

(1) According to at least one embodiment of the present invention, a method of heat-treating for a metal molded article includes: a shape holding layer formation step of forming on a shape holding layer having a melting point higher than a solidus temperature Ts of a composition of the metal molded article on a surface of the metal molded article by treating the metal molded article; and a first heat-treatment step of performing a first heat treatment on the metal molded article at a first temperature T1, after forming the shape holding layer. When a reference temperature Ta is a temperature lower than the solidus temperature Ts by 100° C., and Tm is the melting point of the shape holding layer, the shape holding layer formation step and the first heat-treatment step are performed so as to satisfy an expression Ta≤T1≤Tm.

According to the above method for heat-treating a metal molded article (1), even in a case where heat treatment is performed on the metal molded article at a high temperature (the first temperature T1) that is equal to or higher than the reference temperature Ta relatively close to the solidus temperature Ts at which a liquid phase starts to appear in the metal structure of the metal molded article, a shape holding layer having a melting point higher than the first temperature T1 and the solidus temperature Ts of the composition of the metal molded article is formed on the surface of the metal molded article, and thus it is possible to suppress deformation of the metal molded article due to strength deterioration or partial melting under a high temperature. Thus, by heat treatment in a high-temperature region near the solidus temperature Ts or a high-temperature region not lower than the solidus temperature Ts, it is possible to change the characteristics of the metal molded article appropriately while suppressing deformation of the metal molded article.

Further, in the first heat treatment, the first temperature T1 may be changed with time within a range that satisfies the expression Ta≤T1≤Tm, or the first temperature T1 may be constant regardless of time.

(2) In some embodiments, in the above method for heat-treating a metal molded article (1), when a reference temperature Tb is a temperature lower than the solidus temperature Ts by 50° C., the first heat-treatment step is performed so as to satisfy an expression Tb≤T1.

According to the above method for heat-treating a metal molded article (2), even in a case where heat treatment is performed on the metal molded article at a high temperature (the first temperature T1) that is equal to or higher than the reference temperature Tb even closer to the solidus temperature Ts at which a liquid phase starts to appear in the metal structure of the metal molded article, a shape holding layer having a melting point Tm higher than the first temperature T1 and the solidus temperature Ts of the composition of the metal molded article is formed on the surface of the metal molded article, and thus it is possible to suppress deformation of the metal molded article due to strength deterioration or partial melting under a high temperature. Thus, by heat treatment in a high-temperature region near the solidus temperature Ts or a high-temperature region not lower than the solidus temperature Ts, it is possible to change the characteristics of the metal molded article appropriately while suppressing deformation of the metal molded article.

(3) In some embodiments, in the above method for heat-treating a metal molded article (1) or (2), when a reference temperature Tc is a temperature higher than the solidus temperature Ts by 50° C., the first heat-treatment step is performed so as to satisfy an expression T1≤Tc.

According to the above method for heat-treating a metal molded article (3), the shape holding layer suppresses deformation of the metal molded article, and it is possible to suppress deformation due to strength deterioration and partial melting under an excessively high temperature.

(4) In some embodiments, in the above method for heat-treating a metal molded article (3), when a reference temperature Td is a temperature higher than the solidus temperature Ts by 30° C., the first heat-treatment step is performed so as to satisfy an expression T1≤Td.

According to the above method for heat-treating a metal molded article (4), the shape holding layer suppresses deformation of the metal molded article, and it is possible to suppress deformation due to strength deterioration and partial melting under an excessively high temperature.

(5) In some embodiments, in any one of the above methods for heat-treating a metal molded article (1) to (4), the metal molded article contains at least one of an Ni-based heat resistant alloy, a Co-based heat resistant alloy, or a Fe-based heat resistant alloy.

According to the above method for heat-treating a metal molded article (5), in a case where the metal molded article contains at least one of an Ni-based heat resistant alloy, a Co-based heat resistant alloy, or a Fe-based heat resistant alloy, it is possible to change the characteristics of the metal molded article appropriately while suppressing deformation of the metal molded article. For instance, it is possible to change the strength property under a high temperature without causing deformation. The strength property is a particularly important property for an Ni-based heat resistant alloy, a Co-based heat resistant alloy, and a Fe-based heat resistant alloy, which are to be used under a high-temperature environment.

(6) In some embodiments, in any one of the above methods for heat-treating a metal molded article (1) to (5), the metal molded article is produced by a manufacturing method which is one of casting, forging, or 3D additive manufacturing.

According to the above method for heat-treating a metal molded article (6), in a case where the metal molded article is produced by a manufacturing method which is one of casting, forging, or 3D additive manufacturing, it is possible to change the characteristics of the metal molded article appropriately while suppressing deformation of the metal molded article. While a metal molded article having a complex shape can be manufactured by casting, forging, and especially 3D additive manufacturing, using the above heat treatment method (6) makes it possible to change the characteristics of the metal molded article without impairing functions achieved by the complex shape.

(7) In some embodiments, in any one of the above methods for heat-treating a metal molded article (1) to (6), the shape holding layer formation step includes a second heat-treatment step of performing a second heat treatment on the metal molded article at a second temperature T2 lower than the first temperature T1.

According to the above method for heat-treating a metal molded article (7), by performing the second heat treatment on the metal molded article at the second temperature T2 lower than the first temperature T1, it is possible to form the shape holding layer easily on the surface of the metal molded article. Further, in the second heat treatment, the second temperature T2 may be changed with time within a temperature range lower than the first temperature T1, or the second temperature T2 may be constant regardless of time.

(8) In some embodiments, in the above method for heat-treating a metal molded article (7), the second heat treatment and the first heat treatment are performed successively in the same heat treatment furnace.

According to the above method for heat-treating a metal molded article (8), it is possible to cut the step of taking the metal molded article out from the heat treatment furnace after completion of the second heat treatment and moving the metal molded article to another heat treatment for the first heat treatment. Accordingly, it is possible to form the shape holding layer without increasing the man hour.

(9) In some embodiments, in the above method for heat-treating a metal molded article (7) or (8), the second heat treatment is performed under a pressure not lower than 10⁻³ Torr.

Normally, in a case where heat treatment is performed on a metal molded article, heat treatment is performed under a low-pressure condition (high vacuum) of lower than 10⁻³ Torr in order to suppress reaction with components in the atmosphere gas, for instance.

In contrast, in the above method for heat-treating a metal molded article (9), the second heat treatment is performed intentionally under a pressure of not lower than 10⁻³ Torr to form the shape holding layer proactively on the surface of a molded article through reaction with a component in the atmosphere gas. Thus, it is possible to form the shape holding layer effectively on the surface of the metal molded article, and suppress deformation of the metal molded article during the first heat treatment.

(10) In some embodiments, in any one of the above methods for heat-treating a metal molded article (7) to (9), the second heat treatment includes forming, as the shape holding layer on the surface of the metal molded article, a reaction layer of the metal molded article and an atmosphere gas component, an absentee layer where at least one constituent element of the metal molded article is absent and which is generated in accordance with formation of the reaction layer, or both of the reaction layer and the absentee layer.

According to the above method for heat-treating a metal molded article (10), it is possible to let the reaction layer, the absentee layer, or both of the oxidized scale and the element absentee layer as the shape holding layer, and thus it is possible to suppress deformation of the metal molded article easily during the first heat treatment.

(11) In some embodiments, in the above method for heat-treating a metal molded article (10), the second heat treatment includes forming, as the shape holding layer on the surface of the metal molded article, both of an oxidized scale as the reaction layer and the absentee layer generated in accordance with formation of the oxidized scale.

According to the above method for heat-treating a metal molded article (11), it is possible to let both of the oxidized scale being the reaction layer and the absentee layer as the shape holding layer, and thus it is possible to suppress deformation of the metal molded article easily during the first heat treatment.

(12) In some embodiments, in any one of the above methods for heat-treating a metal molded article (1) to (11), the shape holding layer formation step includes a coating step of coating the surface of the metal molded article by spraying, evaporation coating, or a slurry immersing method.

According to the above method for heat-treating a metal molded article (12), the coating layer formed on the surface of the metal molded article, the reaction layer of the coating layer and the metal molded article, or both of the coating layer and the reaction layer function as the shape holding layer, and thus it is possible to suppress deformation of the metal molded article easily during the first heat treatment. Furthermore, depending on the type of the coating material, it is possible to remove the coating material easily by surface processing after the first heat treatment. For instance, in a case where a silica coating, which is a type of ceramic coating, is used, it is possible to remove the silica coating easily by alkali melting or the like.

(13) In some embodiments, in the above method for heat-treating a metal molded article (12), the coating step includes coating the surface of the metal molded article with at least one of a ceramic, a metal having a melting point higher than the solidus temperature of the composition of the metal molded article, or a metal which is reactive to the metal molded article, and the coating step includes forming, as the shape holding layer on the surface of the metal molded article, a coating layer, a reaction layer of the coating layer and the metal molded article, or both of the coating layer and the reaction layer.

According to the above method for heat-treating a metal molded article (13), the coating layer containing at least one of a ceramic, a metal having a melting point higher than the solidus temperature of the composition of the metal molded article, or a reaction layer with the metal molded article, the reaction layer of the coating layer and the metal molded article, or both of the coating layer and the reaction layer function as the shape holding layer, and thus it is possible to suppress deformation of the metal molded article easily during the first heat treatment.

(14) In some embodiments, in any one of the above methods for heat-treating a metal molded article (1) to (13), the shape holding layer forming step includes a plating step of plating the surface of the metal molded article, and the plating step includes forming, as the shape holding layer on the surface of the metal molded article, a reaction layer of a plating layer and the metal molded article.

According to the above method for heat-treating a metal molded article (14), the reaction layer of the plating layer formed on the surface of the metal molded article and the metal molded article functions as the shape holding layer, and thus it is possible to suppress deformation of the metal molded article easily during the first heat treatment. Further, it is possible to achieve a high adhesion property between the metal molded article and the plating layer, and it is possible to form a fine shape holding layer.

(15) In some embodiments, any one of the above methods for heat-treating a metal molded article (1) to (14) further includes a post heat-treatment step of performing a heat treatment on the metal molded article further after the first heat-treatment step.

According to the above method for heat-treating a metal molded article (15), it is possible to change the characteristics of the metal molded article appropriately by post heat treatment.

(16) In some embodiments, in the above method for heat-treating a metal molded article (15), the post heat-treatment step includes a hot isostatic press step of performing the heat treatment while pressurizing the metal molded article.

According to the above method for heat-treating a metal molded article (16), it is possible to achieve the effect to remove internal defects of the metal molded article, for instance, in accordance with the composition of the metal molded article.

(17) According to at least one embodiment of the present invention, a method of manufacturing a metal molded article includes: a molding step of molding the metal molded article; and a heat-treatment step of performing a heat treatment on the metal molded article molded in the molding step by the method of heat-treating a metal molded article according to any one of the above (1) to (16).

According to the above method of manufacturing a metal molded article (17), the method includes a heat-treatment step of performing a heat treatment by the heat treatment method according to any one of the above (1) to (16), and thus it is possible to suppress deformation of the metal molded article and manufacture a metal molded article having a desired shape and desired characteristics.

(18) In some embodiments, in the above method of manufacturing a metal molded article (17), the molding step includes molding the metal molded article by 3D additive manufacturing.

According to the above method for heat-treating a metal molded article (18), in a case where a metal molded article is molded by 3D additive manufacturing, deformation of the metal molded article is suppressed, and thus it is possible to manufacture a metal molded article having a desired shape while maintaining an extremely complicated shape obtained by 3D additive manufacturing.

### Advantageous Effects

According to at least one embodiment of the present invention, it is possible to provide a method for heat-treating a metal molded article and a manufacturing method whereby it is possible to change the characteristics of the metal molded article appropriately while suppressing deformation of the metal molded article.

### BRIEF DESCRIPTION OF DRAWINGS

FIG. 1 is a flowchart of a method of manufacturing a metal molded article according to an embodiment.

FIG. 2 is a diagram for describing the shape holding layer formation step.

FIG. 3 is a diagram showing the relationship between the temperature (° C.) and the liquid phase ratio (mol %).

FIG. 4 is a flowchart of a method of manufacturing a metal molded article according to an embodiment.

FIG. 5 is a flowchart of a method of manufacturing a metal molded article according to an embodiment.

FIG. 6 is a diagram for describing the method of determining the desirable thickness of the shape holding layer for preventing deformation of the metal molded article.

FIG. 7 is a cross-sectional view showing a shape holding layer formed on the surface of the metal molded article.

FIG. 8 is a cross-sectional view showing a metal molded article according to a comparative example deformed by partial melting.

FIG. 9 is a diagram showing a state where partial melting has occurred in a grain boundary as a result of performing heat treatment on an Ni-based heat resistant alloy at a temperature near the solidus temperature.

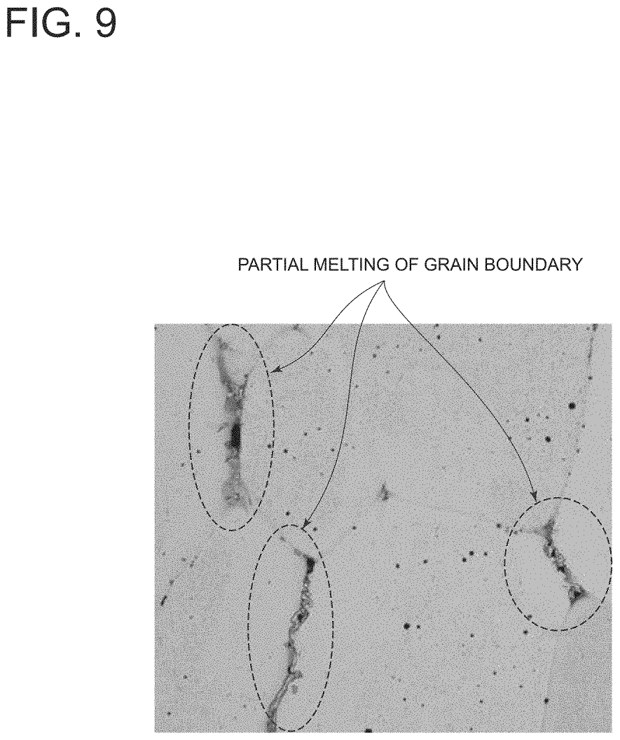

FIG. 10 is a flowchart for describing the slurry immersing method.

FIG. 11 is a diagram for describing a slurry immersing step.

FIG. 12 is a diagram for describing a sanding step.

### DETAILED DESCRIPTION

Embodiments of the present invention will now be described in detail with reference to the accompanying drawings. It is intended, however, that unless particularly identified, dimensions, materials, shapes, relative positions and the like of components described in the embodiments shall be interpreted as illustrative only and not intended to limit the scope of the present invention.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

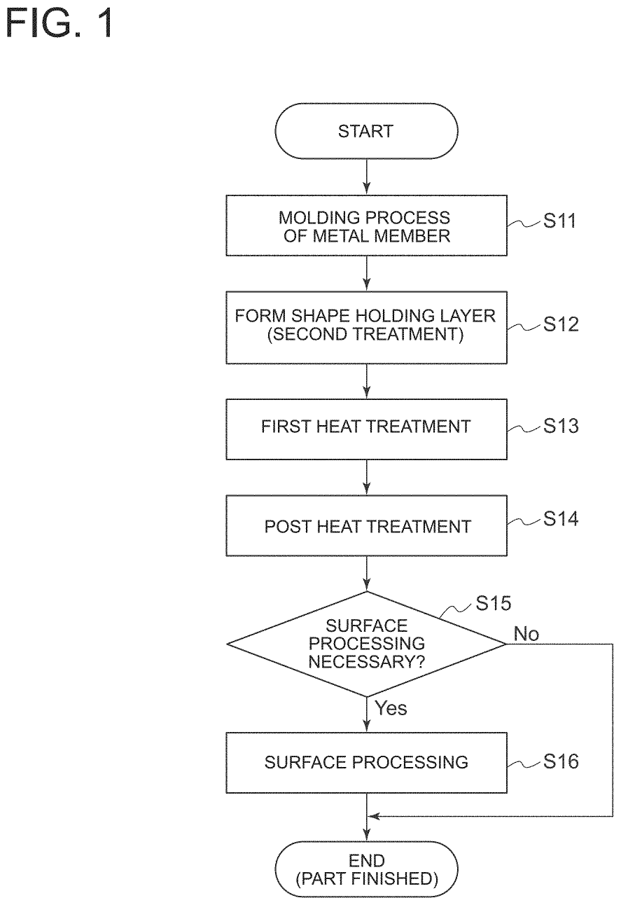

FIG. 1 is a flowchart of a method of manufacturing a metal molded article according to an embodiment.

First, in S11, a metal molded article is molded by performing a molding process of a metal member (molding step).

In S11, the metal molded article is formed of, for instance, an Ni-based heat resistant alloy, a Co-based heat resistant alloy, a Fe-based heat resistant alloy, or another metal material. Furthermore, the metal molded article is formed by a manufacturing method which is one of casting, forging, or 3D additive manufacturing.

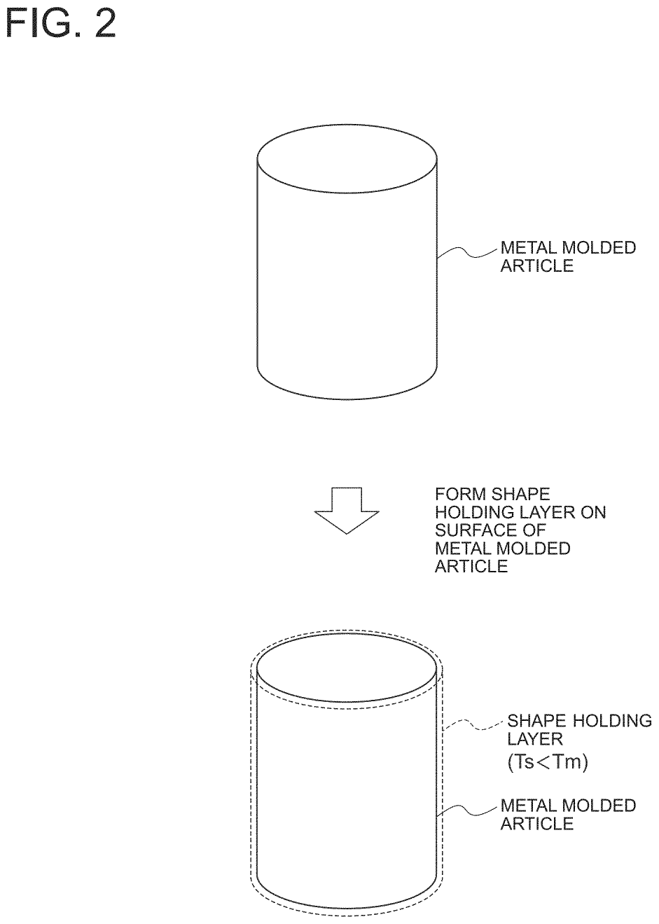

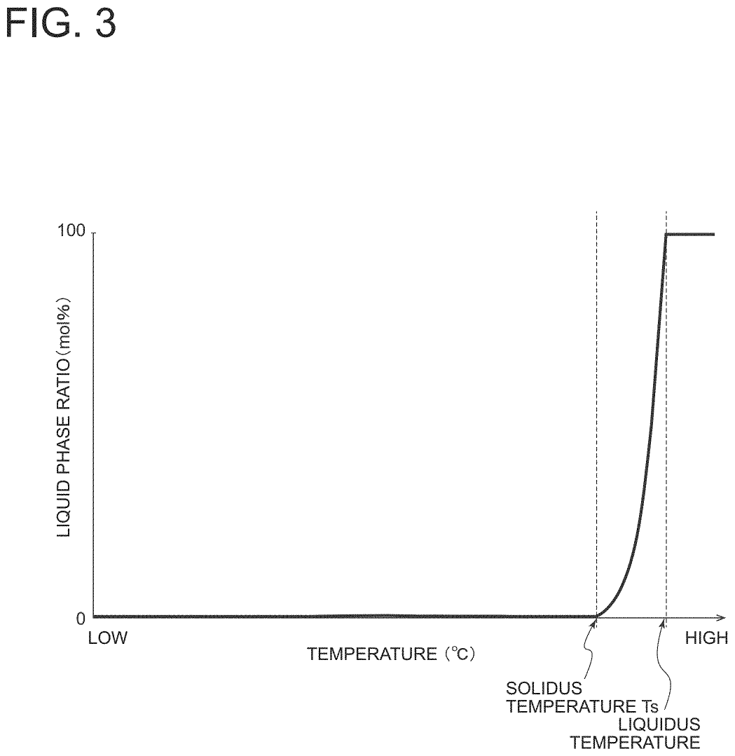

Next, in S12, as depicted in FIG. 2, the metal molded article is treated so as to form, on the surface of the metal molded article, a shape holding layer having a melting point Tm higher than the solidus temperature Ts of the composition of the metal molded article (shape holding layer formation step). A solidus is a curve that indicates the boundary between a region where solid and liquid are balanced and a region where solid exists stably, in a temperature-composition map of a multiple component system. The solidus temperature Ts is, as depicted in FIG. 3, the temperature at which solid starts to melt (the temperature at which the liquid phase ratio starts to increase from zero). FIG. 3 is a diagram showing the relationship between the temperature (° C.) and the liquid phase ratio (mol %). The shape holding layer formation step will be described later in detail.

After forming the shape holding layer in the shape holding layer formation step, in S13, the first heat treatment is performed on the metal molded article at the first temperature T1 (first heat treatment step). Herein, when the reference temperature Ta is a temperature lower than the solidus temperature Ts by 100° C., the shape holding layer formation step and the first heat treatment step are performed so as to satisfy an expression Ta≤T1≤Tm. Further, in the first heat treatment, the first temperature T1 may be changed with time within a range that satisfies the expression Ta≤T1≤Tm, or the first temperature T1 may be constant regardless of time. Further, when the reference temperature Te is a temperature lower than the solidus temperature Ts by 70° C., the shape holding layer formation step and the first heat treatment step may be performed so as to satisfy an expression Te≤T1≤Tm.

Next, in S14, the post heat treatment is performed on the metal molded article (post heat treatment step).

In S14, as the post heat treatment of the metal molded article, vacuum heat treatment may be performed on the metal molded article, or hot isostatic pressing, which is heat-treating the metal molded article while pressurizing the metal molded article, may be performed, or both of the above may be performed.

Next, in S15, it is determined whether to process the surface of the metal molded article, on the basis of whether it is necessary to remove the shape holding layer. If it is determined that it is necessary to process the surface in S15, the surface of the metal molded article is processed in S16, including removal of the shape holding layer, and thereby a metal part is finished. If it is determined that it is unnecessary to process the surface in S15, a metal part is finished without processing the surface.

In the above described flow, even in a case where heat treatment is performed on the metal molded article at a high temperature (the first temperature T1) that is equal to or higher than the reference temperature Ta relatively close to the solidus temperature Ts at which a liquid phase starts to appear in the metal structure of the metal molded article, a shape holding layer having a melting point higher than the first temperature T1 and the solidus temperature Ts of the composition of the metal molded article is formed on the surface of the metal molded article, and thus it is possible to suppress deformation of the metal molded article. Thus, by heat treatment in a high-temperature region near the solidus temperature Ts or a high-temperature region not lower than the solidus temperature Ts, it is possible to change the characteristics of the metal molded article appropriately while suppressing deformation due to strength deterioration and partial melting of the metal molded article due to high temperature.

In an embodiment, when the reference temperature Tb is a temperature lower than the solidus temperature Ts by 50° C., the first heat treatment step shown in S13 is performed so as to satisfy an expression Tb≤T1≤Tm.

In this way, even in a case where heat treatment is performed on the metal molded article at a high temperature (the first temperature T1) that is equal to or higher than the reference temperature Tb even closer to the solidus temperature Ts at which a liquid phase starts to appear in the metal structure of the metal molded article, it is possible to suppress deformation of the metal molded article due to partial melting with the shape holding layer formed on the surface of the metal molded article. Thus, by heat treatment in a high-temperature region near the solidus temperature Ts or a high-temperature region not lower than the solidus temperature Ts, it is possible to change the characteristics of the metal molded article appropriately while suppressing deformation due to partial melting of the metal molded article. Further, when the reference temperature Tf is a temperature lower than the solidus temperature Ts by 30° C., the first heat treatment step may be performed so as to satisfy an expression Tf≤T1≤Tm.

In an embodiment, when the reference temperature Tc is a temperature higher than the solidus temperature Ts by 50° C., the first heat treatment step shown in S13 is performed so as to satisfy an expression T1≤Tc. By performing the first heat treatment so as to satisfy an expression T1≤Tc as described above, it is possible to suppress strength deterioration of the metal molded article due to an excessively high temperature, and suppress deformation of the metal molded article.

In an embodiment, when the reference temperature Td is a temperature higher than the solidus temperature Ts by 30° C., the first heat treatment step shown in S13 is performed so as to satisfy an expression T1≤Td. By performing the first heat treatment so as to satisfy an expression T1≤Td as described above, it is possible to suppress strength deterioration of the metal molded article due to an excessively high temperature, and suppress deformation of the metal molded article. Further, when Tg is a temperature higher than the solidus temperature Ts by 20° C., the first heat treatment step may be performed so as to satisfy an expression T1≤Tg.

Next, the shape holding layer formation step will be described in detail.

In an embodiment, the shape holding layer formation step includes forming the shape holding layer by performing the second heat treatment on the metal molded article at a second temperature T2 lower than the first temperature T1. As described above, by performing the second heat treatment on the metal molded article at the second temperature T2 lower than the first temperature T1, it is possible to form the shape holding layer easily on the surface of the metal molded article. Further, in the second heat treatment, the second temperature T2 may be changed with time within a temperature range lower than the first temperature T1, or the second temperature T2 may be constant regardless of time. Further, when the reference temperature Th is a temperature lower than the first temperature T1 by 10° C., in the shape holding layer formation step, the shape holding layer may be formed by performing the second heat treatment at the second temperature T2 lower than the reference temperature Th.

In an embodiment, the second heat treatment of the shape holding layer formation step and the first heat treatment of the first heat treatment step are performed successively in the same heat treatment furnace. Accordingly, it is possible to cut the step of taking the metal molded article out from the heat treatment furnace after completion of the second heat treatment and moving the metal molded article to another heat treatment for the first heat treatment. Accordingly, it is possible to form the shape holding layer without increasing the man hour.

In an embodiment, the second heat treatment is performed under a low-vacuum pressure of not lower than 10⁻³ Torr (preferably, not lower than 10⁻² Torr). Normally, in a case where heat treatment is performed on a metal molded article, heat treatment is performed under a low-pressure condition (high vacuum) of less than 10⁻³ Torr in order to suppress reaction with components in the atmosphere gas, for instance. In contrast, by performing the second heat treatment intentionally under a low-vacuum pressure of not lower than 10⁻³ Torr to form the shape holding layer proactively on the surface of a molded article through reaction with a component in the atmosphere gas, it is possible to form the shape holding layer effectively on the surface of the metal molded article, and suppress deformation of the metal molded article during the first heat treatment. The second heat treatment in S12 includes forming, as the shape holding layer on the surface of the metal molded article, a reaction layer of the metal molded article and an atmosphere gas component, an absentee layer where at least one constituent element of the metal molded article is absent and which is generated in accordance with formation of the reaction layer, or both of the reaction layer and the absentee layer. For instance, by proactively forming an oxidized scale as a reaction layer on the surface of the metal molded article, an absentee layer where at least one component of the metal molded article (e.g. in a case where the metal molded article is formed of an Ni-based heat resistant alloy, Al, Cr, or the like) is absent is formed under the oxidized scale. Accordingly, it is possible to let both of the oxidized scale and the element absentee layer as the shape holding layer, and thus it is possible to suppress deformation of the metal molded article due to partial melting easily during the first heat treatment.

In an embodiment, the second heat treatment may be performed under a pressure not lower than the atmospheric pressure, instead of under the above low-vacuum pressure. In this case, by performing the second heat treatment under a gas atmosphere of N₂ gas, Ar gas, or ambient air, a reaction layer of the metal molded article and an atmosphere gas component (oxidized layer or nitride layer), an absentee layer where at least one constituent element of the metal molded article is absent and which is generated in accordance with formation of the reaction layer, or both of the reaction layer and the absentee layer are formed on the surface of the metal molded article as the shape holding layer.

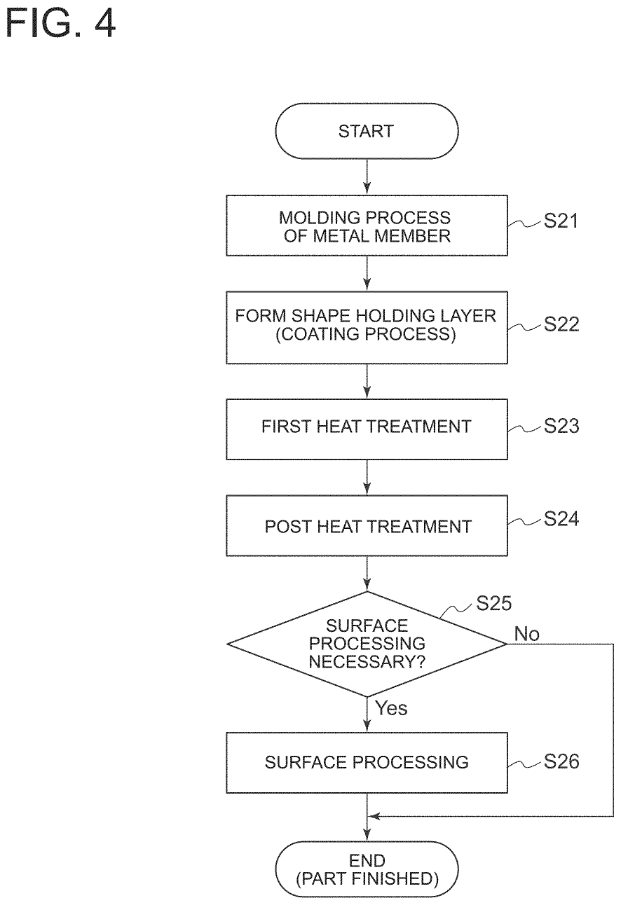

FIG. 4 is a flowchart of a method of manufacturing a metal molded article according to an embodiment. In the flow shown in FIG. 4, steps S21, S23, S24, S25, and S26 are similar to S11, S13, S14, S15, and S16 shown in FIG. 1, and thus not described again.

In S22 depicted in FIG. 4, similarly to S12 in FIG. 1, the metal molded article is treated so as to form, on the surface of the metal molded article, a shape holding layer having a higher melting point Tm than the solidus temperature Ts of the composition of the metal molded article (shape holding layer formation step; see FIG. 2). However, the specific method for forming the shape holding layer is different from the method described above with reference to FIG. 1.

In an embodiment, as shown in S22 of FIG. 4, the shape holding layer formation step includes a coating step of coating the surface of the metal molded article by spraying, evaporation coating, or a slurry immersing method. In the coating step, the surface of the metal molded article is coated with, for instance, at least one of a ceramic, a metal having a melting point Tm higher than the solidus temperature Ts of the composition of the metal molded article, or a metal which is reactive to the metal molded article, by spraying, evaporation coating, or a slurry immersing method, and thereby the shape holding layer is formed. The coating step includes forming, as the shape holding layer on the surface of the metal molded article, a coating layer, a reaction layer of the coating layer and the metal molded article, or both of the coating layer and the reaction layer.

Accordingly, the coating layer formed on the surface of the metal molded article, the reaction layer of the coating layer and the metal molded article, or both of the coating layer and the reaction layer function as the shape holding layer, and thus it is possible to suppress deformation of the metal molded article due to partial melting easily during the first heat treatment.

Further, in a case where coating is performed by evaporation coating, the coating layer may be formed on the surface of the metal molded article by CVD coating or aluminizing. As a method of aluminizing, a packing method can be used, for instance. In the packing method, an aluminum diffusion layer is formed on the surface of the metal molded article through a packing step that uses a powder mixture containing an inert material, an aluminum supply source, and a halide activator. The metal molded article to be coated with aluminum is housed in a box together with the above powder mixture and covered with a pack formed of the powder mixture, where the pack functions as the shape holding layer.

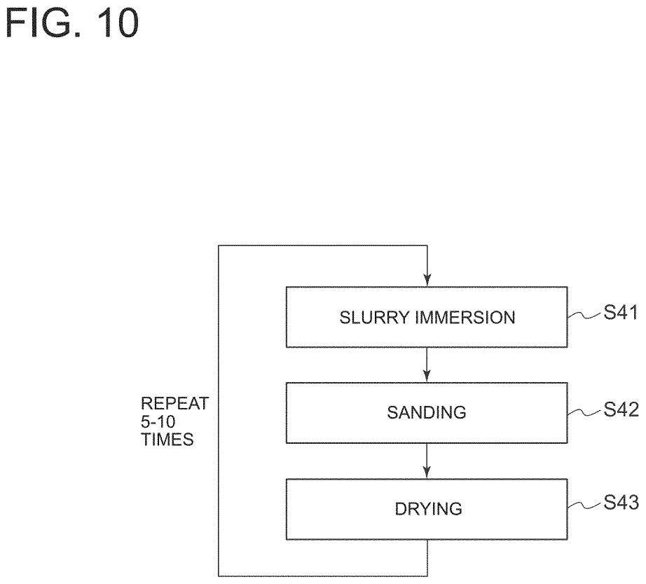

Furthermore, the slurry immersing method is performed as depicted in FIG. 10, for instance.

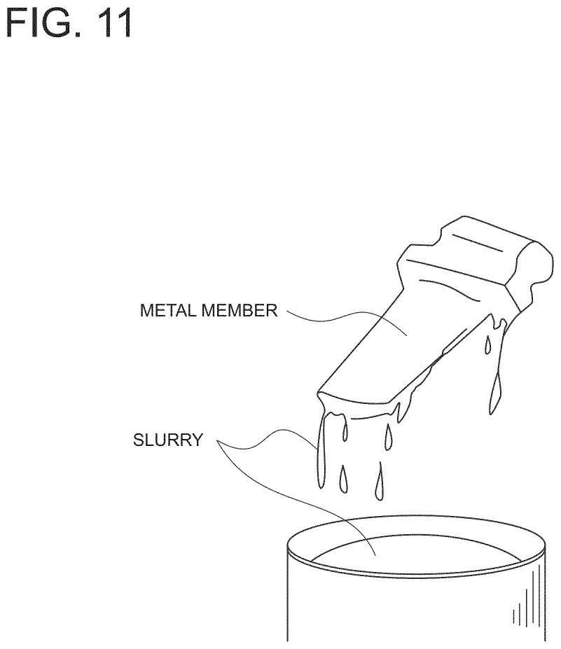

Firstly, in S41, as depicted in FIG. 11, the surface of the metal molded article is coated by immersing the metal molded article in slurry (slurry immersing step). Herein, “slurry” refers to a liquid where ceramic flour (fine ceramic particles) are suspended by a dispersing agent.

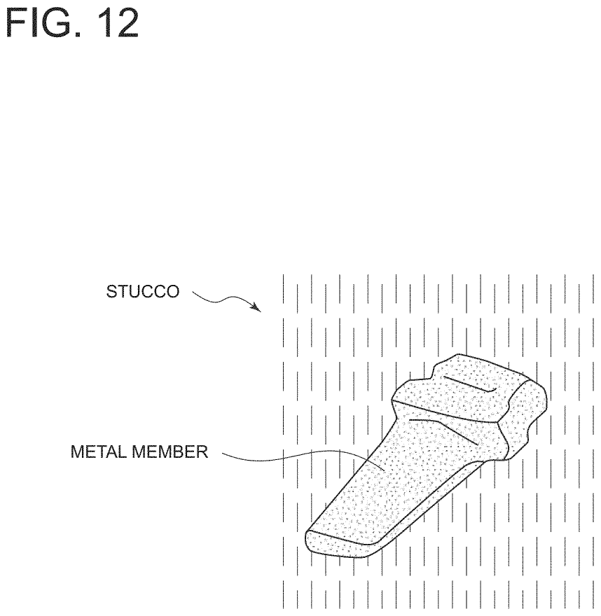

Immediately after S41, in S42, a ceramic layer is formed on the surface of the metal molded article by spreading stucco over the surface of the metal member as depicted in FIG. 12 (sanding step). Herein, “stucco” refers to ceramic particles. Further, in S43, the metal molded article is dried. Furthermore, S41 to S43 are repeated 5 to 10 times, and coating of the metal molded article is completed.

Further, while both of the slurry immersing step and the sanding step are performed in FIG. 10, the sanding step of S42 may not necessarily be performed in another slurry immersing method, and only the slurry immersing step of S41 and the drying step of S43 may be performed.

Further, in a case where the shape holding layer is formed by the above coating step, it is possible to remove the shape holding layer by a surface processing in step S26 easily, depending on the type of the coating material. For instance, in a case where a silica coating, which is a type of ceramic coating, is used, it is possible to remove the silica coating easily by alkali melting or the like.

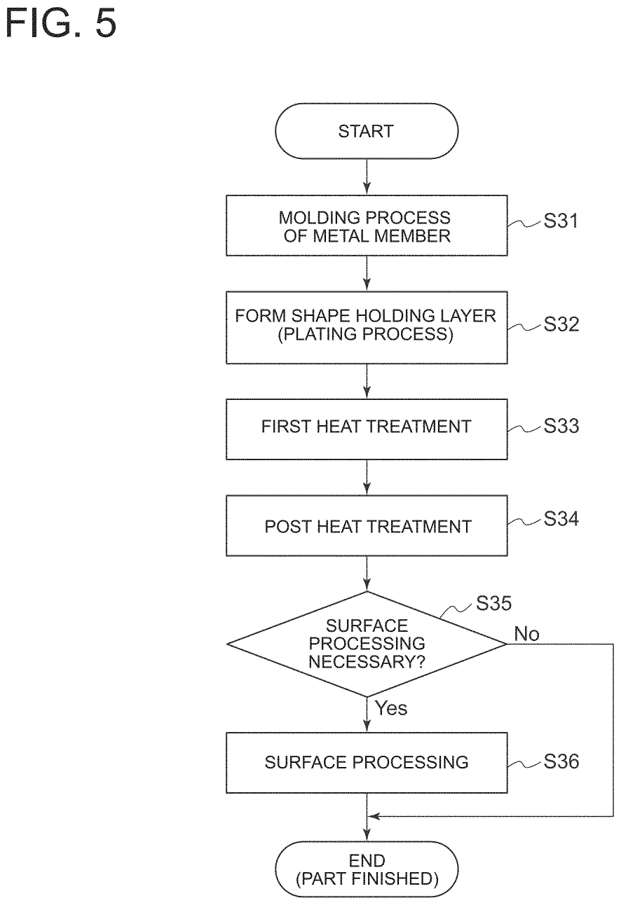

FIG. 5 is a flowchart of a method of manufacturing a metal molded article according to an embodiment. In the flow shown in FIG. 5, steps S31, S33, S34, S35, and S36 are similar to S11, S13, S14, S15, and S16 shown in FIG. 1, and thus not described again.

In S32 depicted in FIG. 5, similarly to S12 in FIG. 1, the metal molded article is treated so as to form, on the surface of the metal molded article, a shape holding layer having a higher melting point Tm than the solidus temperature Ts of the composition of the metal molded article (shape holding layer formation step; see FIG. 2). However, the specific method for forming the shape holding layer is different from the method described above with reference to FIG. 1.

In an embodiment, as shown in S32 of FIG. 5, the shape holding layer formation step includes a plating step of plating the surface of the metal molded article. In the plating step, a plating layer is formed on the surface of the metal molded article with metal that is reactive to the metal molded article. The plating step includes forming a reaction layer of the plating layer and the metal molded article on the surface of the metal molded article as the shape holding layer.

Accordingly, the reaction layer formed on the surface of the metal molded article functions as the shape holding layer, and thus it is possible to suppress deformation of the metal molded article due to partial melting easily during the first heat treatment. Further, in a case where the shape holding layer is formed by the above plating step, it is possible to achieve a high adhesion property between the metal molded article and the plating layer, and it is possible to form a fine shape holding layer.

Herein, in a case where the shape holding layer is formed on the surface of the metal molded article by the method described with reference to FIG. 1, 4, or 5, the desirable thickness for preventing deformation of the metal molded article due to partial melting will be described with examples.

The desirable thickness of the shape holding layer for preventing deformation of the metal molded article due to partial melting is a thickness that is sufficient to maintain the shape of the metal molded article during the first heat treatment at the first temperature T1 relatively close to the solidus temperature Ts.

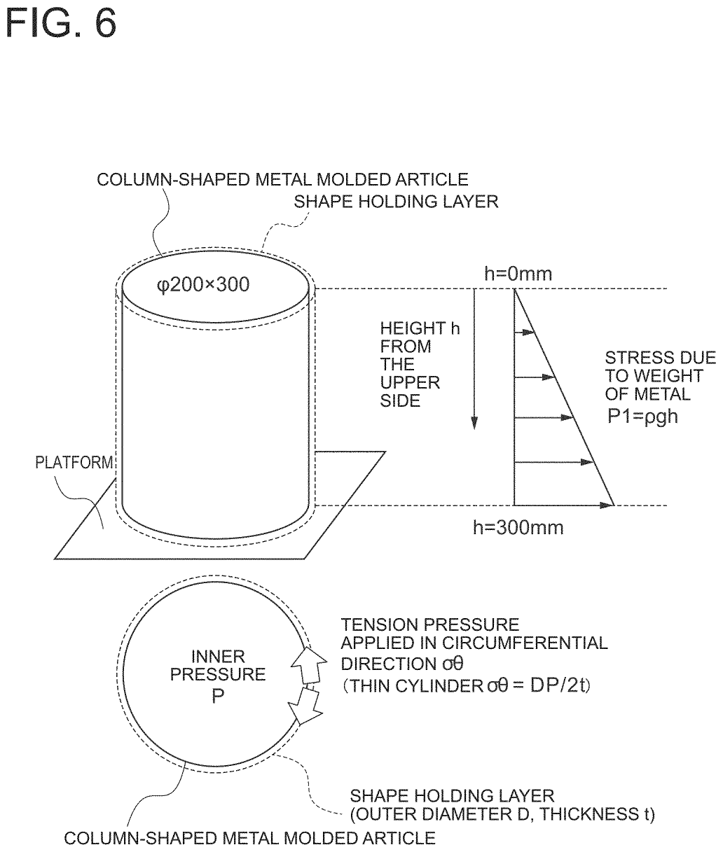

For instance, as depicted in FIG. 6, assume a case where the first heat treatment is performed on a metal molded article having a column shape of 200 mm diameter and 300 mm height placed on a platform. Herein, the density p of the metal molded article is 8 (g/cm³), and is constant regardless of the temperature and the state. Further, it is assumed that a shape holding layer is formed on the surface of the metal molded article, and the yield stress σy of the shape holding layer at the heat treatment temperature (first temperature T1) is 0.2×10⁶−2×10⁶ Pa.

In this case, it is assumed that the grain boundary strength of metal of the metal molded article decreases due to partial melting, and 1-10% of the weight of the metal molded article cannot be supported and is applied to the inner side of the shape holding layer. Herein, it is assumed that the lower side of the metal molded article is on the platform and thus does not deform. Thus, only the stress in the circumferential direction is taken into consideration.

When h is the height of the upper side of the metal molded article measured downward in the vertical direction, the stress P1 applied to the metal molded article due to the weight of the metal molded article at the position of the height h is expressed by an expression P=ρgh, and the maximum P1max of the stress P1 is P1max=ρgh=23537 (Pa), at the position h=300 mm. Thus, on the assumption that 1-10% of the weight of the metal molded article is applied to the shape holding layer, the pressure applied to the inner side of the shape holding layer is P=235-2354 (Pa).

Furthermore, assuming that the shape holding layer has a thin cylindrical shape and when D is the outer diameter of the shape holding layer and t is the thickness of the shape holding layer, the stress σθ applied to the shape holding layer in the circumferential direction is calculated by an expression σθ=DP/2t, and thus a relational expression 23.5/t<σθ<235/t (Pa) is derived. From the above relational expression and relational expressions to be satisfied so that σθ does not exceed the yield stress of the shape holding layer (σθ<0.2×10⁶ and σθ<2×10⁶), a relational expression 12 μm<t<1175 μm is obtained.

Thus, in the above example, the desirable thickness t of the shape holding layer for preventing deformation of the metal molded article due to partial melting is 12 μm to 1.2 mm.

As described above, in an embodiment, the necessary thickness of the shape holding layer may be determined in advance on the basis of the estimated stress applied to the shape holding layer during the first heat treatment, and a shape holding layer having a thickness not smaller than the necessary thickness determined in advance may be formed on the surface of the metal molded article in the shape holding layer formation step.

Next, with regard to steps S11 to S13 of the manufacturing method of the metal molded article depicted in FIG. 1, the first more specific example will be described below.

First, in S11, a metal molded article made of an Ni-based heat resistant alloy is molded by performing a molding processing of an Ni-based heat resistant alloy (molding step). Herein, a metal molded article of a square pillar shape having 10 mm sides and 70 mm length is molded. The solidus temperature Ts of the Ni-based heat resistant alloy is 1300° C., according to differential thermal analysis.

Next, in S12, the second heat treatment is performed on the metal molded article at a low vacuum level of 10⁻³ Torr (shape holding layer formation step). In the second heat treatment, a heat treatment is performed on the metal molded article for 10 minutes while increasing the temperature 1200-1260° C., which is the second temperature T2, at a constant rate.

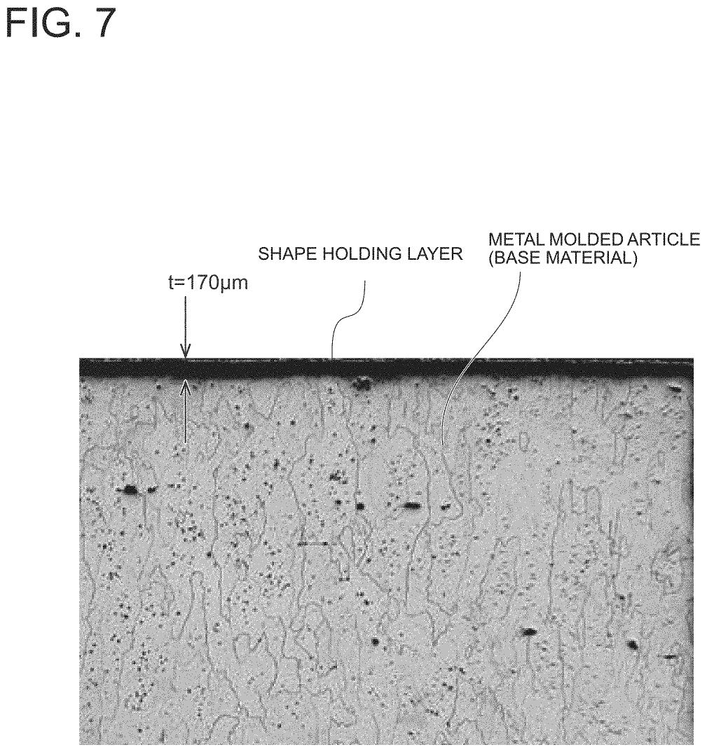

Accordingly, a shape holding layer having a melting point Tm higher than the solidus temperature Ts of the Ni-based heat resistant alloy is formed on the surface of the metal molded article. Herein, an oxidized scale and an element absentee layer (absentee layer where Al and Cr are absent) generated under the oxidized scale in accordance with formation of the oxidized scale are formed on the surface of the metal molded article, and the surface layer including the oxidized scale and the element absentee layer functions as the shape holding layer. According to the inventors of the present invention, it was confirmed that a shape holding layer of approximately 170 μm thickness was formed (see FIG. 7). Further, while the duration of the second heat treatment is not particularly limited, it is possible to form the shape holding layer preferably by performing the second heat treatment for 5 minutes or longer, or more preferably, 10 minutes or longer.

Next, in S13, the first heat treatment is performed on the metal molded article at a low vacuum level of 10⁻³ Torr (first heat treatment step). In the first heat treatment, the first heat treatment is performed on the metal molded article for 24 hours at the temperature 1270° C., which is the first temperature T1 (first heat treatment step). The first heat treatment is performed successively after the second heat treatment in the same heat treatment furnace, without opening the heat treatment furnace where the metal molded article is housed inside.

Herein, when the reference temperature Ta is a temperature lower than the solidus temperature Ts by 100° C., Ta=1200° C., and the shape holding layer formation step and the first heat treatment step are performed so as to satisfy an expression Ta≤T1≤Tm. Further, when the reference temperature Tb is a temperature lower than the solidus temperature Ts by 50° C., Tb=1250° C., and the shape holding layer formation step and the first heat treatment step are performed so as to satisfy an expression Tb≤T1≤Tm. Further, in a case where the shape holding layer includes a plurality of layers (oxidized scale and element absentee layer) as described above, the shape holding layer formation step and the first heat treatment step are performed so that the first temperature T1 becomes lower than the melting point Tm of at least one of the plurality of layers (preferably, all of the layers).

In this way, even in a case where heat treatment is performed on the metal molded article at a high temperature (the first temperature T1) that is equal to or higher than the reference temperature Ta relatively close to the solidus temperature Ts at which a liquid phase starts to appear in the metal structure of the metal molded article, it is possible to suppress deformation of the metal molded article due to strength deterioration and partial melting at a high temperature with the shape holding layer formed on the surface of the metal molded article. Thus, by heat treatment in a high-temperature region near the solidus temperature Ts or a high-temperature region higher than the solidus temperature Ts, it is possible to change the characteristics of the metal molded article appropriately while suppressing deformation due to strength deterioration and partial melting of the metal molded article at a high temperature.

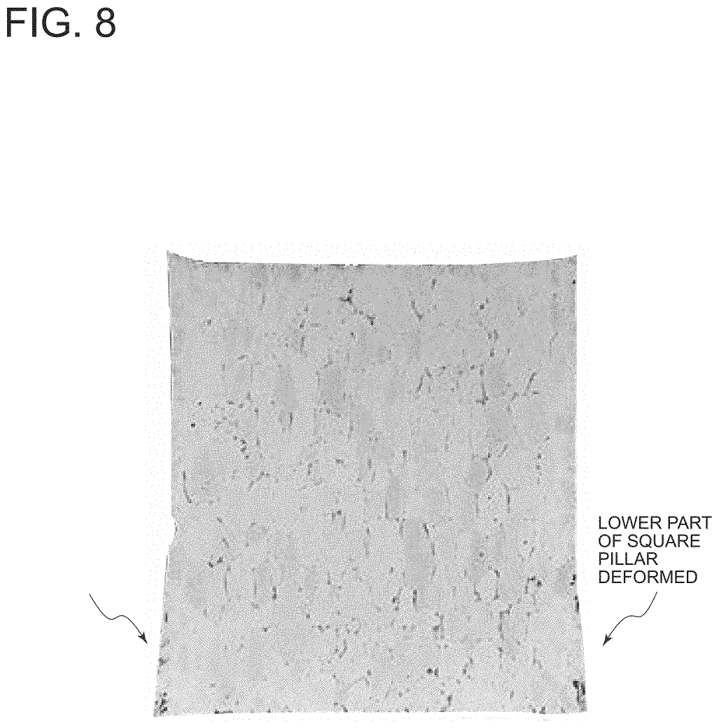

FIG. 8 is a cross-sectional view showing a metal molded article according to a comparative example deformed by strength deterioration and partial melting at a high temperature. In the comparative example depicted in FIG. 8, a heat treatment is performed on the above described metal molded article of an Ni-based heat resistant alloy having a square pillar shape at 1270° C. for 24 hours without performing the shape holding layer formation step of S12 depicted in FIG. 1. The heat treatment was performed under a vacuum level of 10⁻⁴ Torr. In the comparative example depicted in FIG. 8, the shape holding layer formation layer is not formed on the surface of the metal molded article, and thermal deformation occurred at the lower part of the metal molded article having a square pillar shape due to strength deterioration and partial melting due to a high temperature.

Next, with regard to steps S11 to S13 of the manufacturing method of the metal molded article depicted in FIG. 1, the second more specific example will be described below.

First, in S11, a metal molded article made of an Ni-based heat resistant alloy is molded by performing a molding process of an Ni-based heat resistant alloy (molding step). Herein, a metal molded article having a square pillar shape having 10 mm sides and 70 mm length is molded. The solidus temperature Ts of the Ni-based heat resistant alloy is 1300° C., according to differential thermal analysis.

In S12, the second heat treatment is performed on the metal molded article at a low vacuum level of 10⁻³ Torr (shape holding layer formation step). In the second heat treatment, a heat treatment is performed on the metal molded article for 1 hour at temperature 1200° C., which is the second temperature T2.

Accordingly, a shape holding layer having a melting point Tm higher than the solidus temperature Ts of the Ni-based heat resistant alloy is formed on the surface of the metal molded article. Herein, an oxidized scale and an element absentee layer (absentee layer where Al and Cr are absent) generated under the oxidized scale in accordance with formation of the oxidized scale are formed on the surface of the metal molded article, and the surface layer including the oxidized scale and the element absentee layer functions as the shape holding layer.

Next, in S13, the first heat treatment is performed on the metal molded article at a low vacuum level of 10⁻³ Torr (first heat treatment step). In the first heat treatment, the first heat treatment is performed on the metal molded article for 24 hours at the temperature 1230° C., which is the first temperature T1 (first heat treatment step). The first heat treatment is performed successively after the second heat treatment in the same heat treatment furnace, without opening the heat treatment furnace where the metal molded article is housed inside.

Herein, when the reference temperature Ta is a temperature lower than the solidus temperature Ts by 100° C., Ta=1200° C., and the shape holding layer formation step and the first heat treatment step are performed so as to satisfy an expression Ta≤T1≤Tm. Further, in a case where the shape holding layer includes a plurality of layers (oxidized scale and element absentee layer) as described above, the shape holding layer formation step and the first heat treatment step are performed so that the first temperature T1 becomes lower than the melting point Tm of at least one of the plurality of layers (preferably, all of the layers).

In this way, even in a case where heat treatment is performed on the metal molded article at a high temperature (the first temperature T1) that is equal to or higher than the reference temperature Ta relatively close to the solidus temperature Ts at which a liquid phase starts to appear in the metal structure of the metal molded article, it is possible to suppress deformation of the metal molded article due to strength deterioration with the shape holding layer formed on the surface of the metal molded article. Thus, by heat treatment in a high-temperature region near the solidus temperature Ts or a high-temperature higher than the solidus temperature Ts, it is possible to change the characteristics of the metal molded article appropriately while suppressing deformation due to strength deterioration of the metal molded article.

Next, with regard to steps S11 to S13 of the manufacturing method of the metal molded article depicted in FIG. 1, the third more specific example will be described below.

First, in S11, a metal molded article made of an Ni-based heat resistant alloy is molded by performing a molding processing of an Ni-based heat resistant alloy (molding step). Herein, a metal molded article of a square pillar shape having 10 mm sides and 70 mm length is molded. The solidus temperature Ts of the Ni-based heat resistant alloy is 1300° C., according to differential thermal analysis.

In S12, the second heat treatment is performed on the metal molded article at a low vacuum level of 10⁻¹ Torr (shape holding layer formation step). In the second heat treatment, a heat treatment is performed on the metal molded article for 1 hour at temperature 1200° C., which is the second temperature T2.

Accordingly, a shape holding layer having a melting point Tm higher than the solidus temperature Ts of the Ni-based heat resistant alloy is formed on the surface of the metal molded article. Herein, an oxidized scale and an element absentee layer (absentee layer where Al and Cr are absent) generated under the oxidized scale in accordance with formation of the oxidized scale are formed on the surface of the metal molded article, and the surface layer including the oxidized scale and the element absentee layer functions as the shape holding layer.

Next, in S13, the first heat treatment is performed on the metal molded article at a low vacuum level of 10⁻¹ Torr (first heat treatment step). In the first heat treatment, the first heat treatment is performed on the metal molded article for 2 hours at the temperature 1280° C., which is the first temperature T1 (first heat treatment step). The first heat treatment is performed after the second heat treatment not successively after opening the heat treatment furnace where the metal molded article is housed inside.

Herein, when the reference temperature Ta is a temperature lower than the solidus temperature Ts by 100° C., Ta=1200° C., and the shape holding layer formation step and the first heat treatment step are performed so as to satisfy an expression Ta≤T1≤Tm. Further, in a case where the shape holding layer includes a plurality of layers (oxidized scale and element absentee layer) as described above, the shape holding layer formation step and the first heat treatment step are performed so that the first temperature T1 becomes lower than the melting point Tm of at least one of the plurality of layers (preferably, all of the layers).

In this way, even in a case where heat treatment is performed on the metal molded article at a high temperature (the first temperature T1) that is equal to or higher than the reference temperature Ta relatively close to the solidus temperature Ts at which a liquid phase starts to appear in the metal structure of the metal molded article, it is possible to suppress deformation of the metal molded article due to strength deterioration and partial melting at a high temperature with the shape holding layer formed on the surface of the metal molded article. Thus, by heat treatment in a high-temperature region near the solidus temperature Ts or a high-temperature higher than the solidus temperature Ts, it is possible to change the characteristics of the metal molded article appropriately while suppressing deformation due to strength deterioration and partial melting of the metal molded article at a high temperature.

Next, with regard to steps S11 to S13 of the manufacturing method of the metal molded article depicted in FIG. 1, the fourth more specific example will be described below.

First, in S11, a metal molded article made of an Ni-based heat resistant alloy is molded by performing a molding processing of an Ni-based heat resistant alloy (molding step). Herein, a metal molded article of a square pillar shape having 10 mm sides and 70 mm length is molded. The solidus temperature Ts of the Ni-based heat resistant alloy is 1300° C., according to differential thermal analysis.

In S12, the second heat treatment is performed on the metal molded article in an ambient atmosphere (shape holding layer formation step). In the second heat treatment, a heat treatment is performed on the metal molded article for 10 minutes at temperature 1000° C., which is the second temperature T2.

Accordingly, a shape holding layer having a melting point Tm higher than the solidus temperature Ts of the Ni-based heat resistant alloy is formed on the surface of the metal molded article. Herein, an oxidized scale and an element absentee layer (absentee layer where Al and Cr are absent) generated under the oxidized scale in accordance with formation of the oxidized scale are formed on the surface of the metal molded article, and the surface layer including the oxidized scale and the element absentee layer functions as the shape holding layer.

Next, in S13, the first heat treatment is performed on the metal molded article at a low vacuum level of 10⁻⁴ Torr (first heat treatment step). In the first heat treatment, the first heat treatment is performed on the metal molded article for 2 hours at temperature 1320° C., which is the first temperature T1 (first heat treatment step). The first heat treatment is performed after the second heat treatment not successively after opening the heat treatment furnace where the metal molded article is housed inside.

Herein, when the reference temperature Ta is a temperature lower than the solidus temperature Ts by 100° C., Ta=1200° C., and the shape holding layer formation step and the first heat treatment step are performed so as to satisfy an expression Ta≤T1≤Tm. Further, in a case where the shape holding layer includes a plurality of layers (oxidized scale and element absentee layer) as described above, the shape holding layer formation step and the first heat treatment step are performed so that the first temperature T1 becomes lower than the melting point Tm of at least one of the plurality of layers (preferably, all of the layers).

In this way, even in a case where heat treatment is performed on the metal molded article at a high temperature (the first temperature T1) that is equal to or higher than the reference temperature Ta relatively close to the solidus temperature Ts at which a liquid phase starts to appear in the metal structure of the metal molded article, it is possible to suppress deformation of the metal molded article due to strength deterioration and partial melting at an excessively high temperature with the shape holding layer formed on the surface of the metal molded article. Thus, by heat treatment in a high-temperature region near the solidus temperature Ts or a high-temperature region higher than the solidus temperature Ts, it is possible to change the characteristics of the metal molded article appropriately while suppressing deformation due to strength deterioration and partial melting of the metal molded article due to an excessively high temperature.

Embodiments of the present invention were described in detail above, but the present invention is not limited thereto, and various amendments and modifications may be implemented.

### DESCRIPTION OF REFERENCE NUMERALS

P, P1 Stress
P1max Maximum value
T1 First temperature
T2 Second temperature
Ta, Tb, Tc, Td, Te, Tf, Tg, Th Reference temperature
Tm Melting point
Ts Solidus temperature

1. A method of heat-treating for a metal molded article, comprising:
a shape holding layer formation step of forming on a shape holding layer having a melting point higher than a solidus temperature Ts of a composition of the metal molded article on a surface of the metal molded article by treating the metal molded article; and
a first heat-treatment step of performing a first heat treatment on the metal molded article at a first temperature T1, after forming the shape holding layer,
wherein, when a reference temperature Ta is a temperature lower than the solidus temperature Ts by 100° C., and Tm is the melting point of the shape holding layer,
the shape holding layer formation step and the first heat-treatment step are performed so as to satisfy an expression Ta≤T1≤Tm and
wherein the shape holding layer formation step includes a coating step of coating the surface of the metal molded article by spraying, evaporation coating, or a slurry immersing method.

2. The method of heat-treating for a metal molded article according to claim 1,
wherein, when a reference temperature Tb is a temperature lower than the solidus temperature Ts by 50° C.,
the first heat-treatment step is performed so as to satisfy an expression Tb≤T1.

3. The method of heat-treating for a metal molded article according to claim 1,
wherein, when a reference temperature Tc is a temperature higher than the solidus temperature Ts by 50° C.,
the first heat-treatment step is performed so as to satisfy an expression T1≤Tc.

4. The method of heat-treating for a metal molded article according to claim 3,
wherein, when a reference temperature Td is a temperature higher than the solidus temperature Ts by 30° C.,
the first heat-treatment step is performed so as to satisfy an expression T1≤Td.

5. The method of heat-treating for a metal molded article according to claim 1,
wherein the metal molded article contains at least one of an Ni-based heat resistant alloy, a Co-based heat resistant alloy, or a Fe-based heat resistant alloy.

6. The method of heat-treating for a metal molded article according to claim 1,
wherein the metal molded article is produced by a manufacturing method which is one of casting, forging, or 3D additive manufacturing.

7. The method of heat-treating for a metal molded article according to claim 1,
wherein the shape holding layer formation step includes a second heat-treatment step of performing a second heat treatment on the metal molded article at a second temperature T2 lower than the first temperature T1.

8. The method of heat-treating for a metal molded article according to claim 7,
wherein the second heat treatment and the first heat treatment are performed successively in the same heat treatment furnace.

9. The method of heat-treating for a metal molded article according to claim 7,
wherein the second heat treatment is performed under a pressure not lower than 10⁻³ Torr.

10. The method of heat-treating for a metal molded article according to claim 7,
wherein the second heat treatment includes forming, as the shape holding layer on the surface of the metal molded article, a reaction layer of the metal molded article and an atmosphere gas component, an absentee layer where at least one constituent element of the metal molded article is absent and which is generated in accordance with formation of the reaction layer, or both of the reaction layer and the absentee layer.

11. The method of heat-treating for a metal molded article according to claim 10,
wherein the second heat treatment includes forming, as the shape holding layer on the surface of the metal molded article, both of an oxidized scale as the reaction layer and the absentee layer generated in accordance with formation of the oxidized scale.

12. (canceled)

13. The method of heat-treating for a metal molded article according to claim 12,
wherein the coating step includes coating the surface of the metal molded article with at least one of a ceramic, a metal having a melting point higher than the solidus temperature of the composition of the metal molded article, or a metal which is reactive to the metal molded article, and
wherein the coating step includes forming, as the shape holding layer on the surface of the metal molded article, a coating layer, a reaction layer of the coating layer and the metal molded article, or both of the coating layer and the reaction layer.

14. The method of heat-treating for a metal molded article according to claim 1,
wherein the shape holding layer forming step includes a plating step of plating the surface of the metal molded article, and
wherein the plating step includes forming, as the shape holding layer on the surface of the metal molded article, a reaction layer of a plating layer and the metal molded article.

15. The method of heat-treating for a metal molded article according to claim 1, further including a post heat-treatment step of performing a heat treatment on the metal molded article further after the first heat-treatment step.

16. The method of heat-treating for a metal molded article according to claim 15,
wherein the post heat-treatment step includes a hot isostatic press step of performing the heat treatment while pressurizing the metal molded article.

17. A method of manufacturing a metal molded article, comprising:
a molding step of molding the metal molded article; and
a heat-treatment step of performing a heat treatment on the metal molded article molded in the molding step by the method of heat-treating a metal molded article according to claim 1.

18. The method of manufacturing a metal molded article according to claim 17,
wherein the molding step includes molding the metal molded article by 3D additive manufacturing.
